(19) United States
(12) Patent Application Publication
(10) Pub. No.: US 2026/0178663 A1
(43) Pub. Date: Jun. 25, 2026

(54) GENERATING POSITIONAL ENCODINGS OF DIRECTED GRAPHS

(71) Applicant: DeepMind Technologies Limited, London (GB)

(72) Inventors: Cosmin Paduraru, London (GB); Simon Markus Geisler, Neufahrn bei Freising (DE); Yujia Li, London (GB); Daniel J. Mankowitz, Harpenden (GB); Ali Taylan Cemgil, London (GB)

(21) Appl. No.: 19/126,772

(22) PCT Filed: Nov. 6, 2023
(86) PCT No.: PCT/EP2023/080875

§ 371 Date: May 2, 2025

Related U.S. Application Data
(60) Provisional application No. 63/422,875, filed on Nov. 4, 2022.

(51) Int. Cl. G06F 16/901; G06N 3/045; G06N 3/084

(52) U.S. Cl. CPC G06F 16/9024; G06N 3/045; G06N 3/084

(57) ABSTRACT

Methods and systems for generating positional encodings for nodes in a directed graph. In particular, the positional encodings are directionally-aware and are used to update node features for the nodes of the directed graph before the node feature are processed by a neural network to generate a task prediction for the directed graph.

### BACKGROUND

This specification relates to processing graph data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that processes graph data representing an input directed graph using a neural network to generate a task prediction. The graph includes a set of nodes and a set of directed edges that each connect a respective pair of nodes. The edges are referred to as “directed” because an edge has a direction, i.e., connects a source node to a target node but does not connect the target node to the source node. Thus, the graph data represents a “directed” graph, and not an undirected graph that has only undirected edges.

Prior to processing the graph data using the neural network, the system generates a respective positional encoding for each of the nodes in the graph. The system then uses the positional encodings and respective node features for each of the nodes in the graph to process the graph data using the neural network.

Particular embodiments of the subject matter described in this specification can be implemented so as to realize one or more of the following advantages.

Transformer neural networks (or, more generally, self-attention-based neural networks that include one or more self-attention layers) were originally proposed as a sequence to sequence model for text but have become vital for a wide range of modalities including images, audio, video, and undirected graphs. However, despite the fact that directed graphs are applicable to many fundamental real-world domains, applying such neural networks to directed graphs has not yielded much success.

Many neural networks, e.g. neural networks that perform self-attention operations, require positional encodings, i.e., encodings that reflect the relative positions of the corresponding inputs, to be applied to the inputs to the neural network in order to perform well on a given task. For example, the self-attention operation that is applied by a self-attention layer is generally positionally invariant and benefits from positional encodings. Existing approaches for generating positional encodings can only generate encodings that fail to capture directedness in graphs, leaving them ill-suited for modifying graph data representing a directed graph, e.g. before the data is processed using a neural network that applies self-attention. That is, while existing approaches for generating positional encodings work well for undirected graphs, because they fail to capture directedness, the positional encodings fail to capture the additional information available in a directed graph that is not available in an undirected graph.

This specification, on the other hand, describes techniques for generating positional encodings that capture directedness in graphs. In particular, this specification describes techniques for computing positional encodings using the Magnetic Laplacian of the directed graph. Because the Magnetic Laplacian is computed based on the direction of the edges in the graph, the positional encodings are directionally-aware.

By making use of the described positional encodings, the task predictions generated by the neural network for a variety of tasks are significantly improved. That is, because the described positional encodings capture directedness, the neural network can make use of this additional information, i.e., the extra directionality information that is encoded in the described positional encodings but not encoded in existing positional encodings, to generate improved predictions for any of a variety of tasks that require operating on directed graphs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example graph processing system.

FIG. 1B shows two example architectures of the neural network.

FIG. 2 is a flow diagram of an example process for processing graph data.

FIG. 3 is a flow diagram of an example process for computing positional encodings using the Magnetic Laplacian.

FIG. 4 illustrates eigenvectors for some simple example graphs.

FIG. 5 shows an example architecture of the sign neural network.

FIG. 6 shows results of the described approach.

Like reference numbers and designations in the various drawings indicate like elements.

### DETAILED DESCRIPTION

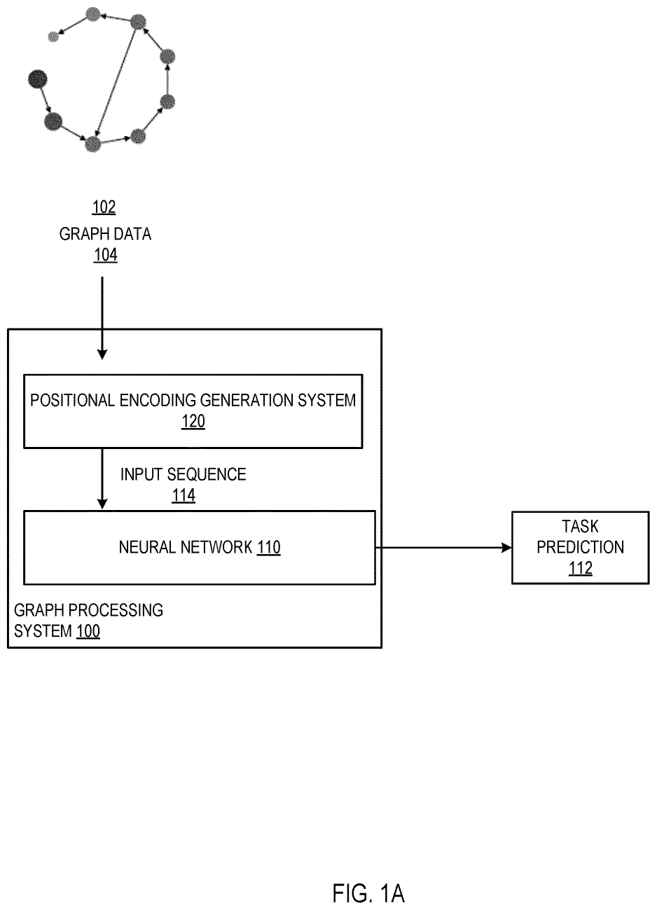

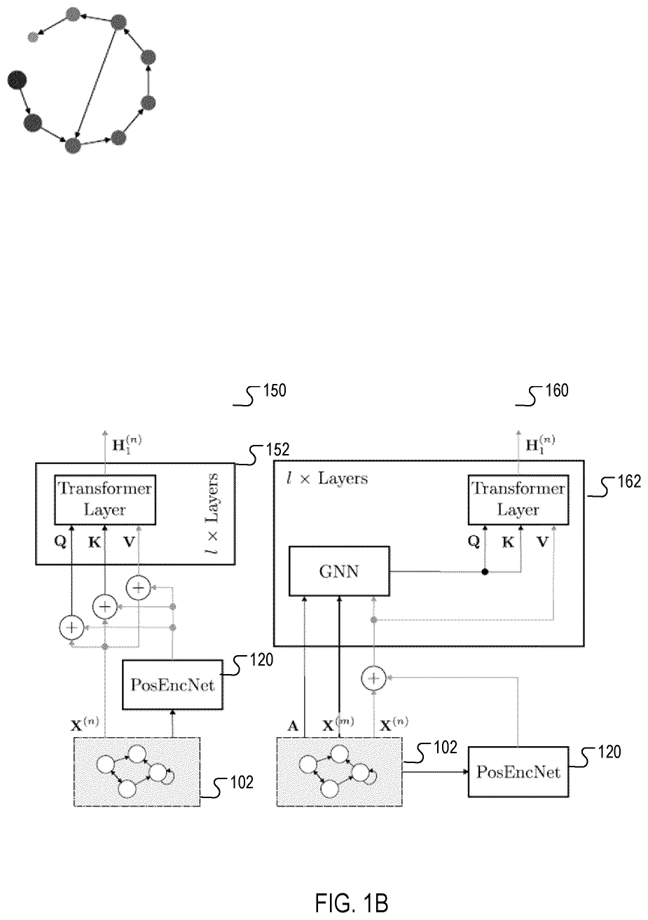

FIG. 1A shows an example graph processing system 100. The graph processing system 100 is an example of a system implemented as computer programs on one or more computers in one or more locations in which the systems, components, and techniques described below are implemented.

The system 100 processes graph data 104 representing an input directed graph 102 using a neural network 110 to generate a predicted output, i.e. a task prediction 112.

The graph 102 includes a set of nodes and a set of directed edges that each connect a respective pair of nodes. The edges are referred to as “directed” because each directed edge has a direction, i.e., connects a source node to a target node but does not connect the target node to the source node. In general an edge represents a relationship between the nodes it connects; in some implementations an edge can have a weight that represents a strength of the relationship. The direction of an edge can represent a direction of information flow, e.g. from an output of the source node to an input of the target node. Although the graph 102 has a set of directed edges, an undirected edge between two nodes can be represented by connecting them with a pair of directed edges with opposite directions.

Generally, the graph 102 can represent a set of entities, i.e., such that each entity is represented by a respective node in the graph, and the task prediction 112 can be any appropriate prediction, e.g. a prediction characterizing one or more of the entities.

The task prediction 112 can be, e.g., a classification prediction, or a regression prediction. A classification prediction can include a respective score for each class in a set of possible classes, where the score for a class can define a likelihood that the set of entities represented by the graph 102 are included in the class. A regression prediction can include one or more numerical values, each drawn from a continuous range of values, that characterize the set of entities represented by the graph 102.

The system 100 described herein is widely applicable and is not limited to one specific implementation. However, for illustrative purposes, a small number of example implementations are described below.

In some implementations, the directed graph 102 can represent a computer program and each node in the graph 102 can represent a respective code segment from the computer program (such as, e.g., a function body or an if statement), and the task prediction 112 can characterize one or more predicted properties of the computer program, e.g., the function represented by the computer program, whether the computer program will compile, whether the computer program contains any bugs, whether the computer program will generate a correct output, and so on. An edge can represent a (directed) flow of information between the code segments represented by the nodes it connects. The node features can be any features that represent the respective code segment. Optionally commutative properties of operations can be represented using edge features. There are many ways of representing computer programs as graphs and the described techniques are not limited to any particular approach; the computer program may comprise source, or executable code, or code for a hardware description language i.e. describing a logic circuit, or in general code in any computer language, e.g. a query language. The predicted output, i.e. the task prediction, may comprise a classification output, e.g. to classify the computer program into two or more classes representing, e.g., whether or not the program will compile correctly; whether or not the program will run without errors, or generate correct output. Or the task prediction may comprise a regression output, e.g. predicting how long a program, database query or the like will take to execute. As another example, the predicted output may comprise a representation, e.g. tokens, of a second computer program for automatically compiling or decompiling the computer program into the second computer program. Training data for such a system may be obtained from any suitable large repository of code.

In some implementations, the graph 102 can represent a real-world physical system, each node in the graph can represent a respective object in the physical system, and the task prediction 112 can characterize a respective predicted future state of one or more real-world objects in the real-world physical system, e.g., a respective position and/or velocity of each of one or more objects in the physical system at a future time point. An edge can represent the influence of one object represented by a node on another, e.g. connected or interacting object, as an example objects connected by a joint. Where one object is large or fixed its influence on another object may be directed; optionally the weight of an edge may represent a magnitude of the influence. Node features may be any features that represent or characterize the respective object, e.g. static features such as object mass or inertia or dynamic features representing object motion, e.g. position, speed, or acceleration. The predicted output can characterize the respective predicted future state of one or more the objects, e.g. as position and/or motion of an object, that can then be used in any suitable manner. For example the prediction may be useful in itself e.g. for collision avoidance, or it may be used for controlling an aspect of the physical system such as one or more of the objects, e.g. in a model predictive control system, to provide object control signals for controlling one or more of the objects dependent upon the predicted future state. Training data for such a system may be obtained from observations of the and/or other physical systems, from the real-world or from simulation.

In some implementations, the graph 102 can represent a real-world physical system that is a computer network, each node in the graph can represent a respective object (device) in the computer network such as a computer or an item of network hardware such as a router. The task prediction 112, which may comprise a classification output, can characterize a predicted state of one or more of the objects in the physical system, e.g. to predict an anomalous state of the object, e.g. to identify a fault in the behavior of the object or network, or to identify presence of a security threat such as a virus or worm. The (directed) edges may represent sender and destination nodes. The node features may be any features that represent or characterize the respective object, e.g. device type or characteristics, port number, and so forth. There are many public datasets of training data for training such system; and/or training data for a particular application may be collected from a sandbox system.

In some implementations, the graph 102 can represent a portion of text, each node in the graph 102 can represent a respective word in the portion of text, and the task prediction 112 can predict, e.g., a sentiment expressed in the portion of text, e.g., positive, negative, or neutral. As another example the text may include text in web pages and/or other associated data, the graph 102 may represent links between the web pages, and the predicted output may characterize the pages, e.g. according to a metric of their value.

In some implementations, the graph 102 can represent a still or moving image, e.g. in 2D or 3D, each node in the graph 102 can represent a respective portion of the image (e.g., a pixel or a region of the image), and the task prediction 112 can characterize, e.g., a class of object depicted in the image. In some such implementations the graph 102 may comprise a so-called “scene graph” with a hierarchical structure in which some, higher nodes represent groupings of objects and some, lower nodes represent subparts of an object. The node features of a node may be any features that represent the respective portion of the image, e.g. the appearance of the portion, and/or other features such as shape or surface normal or motion. The edges can represent spatial and/or logical relationships between the nodes. For example in a scene graph a directed edge may, e.g., represent that the motion of one node should be controlled by another (such as a horse and its rider). The predicted output may be a classification output that can characterize any aspect of the image or part of the image, e.g. an object or characteristic of an object in the image, or may characterize each portion of the image, e.g. for image segmentation; or it may be comprise regression output, e.g. to predict a characteristic of an object in the image, e.g. the age of a person. Any suitable corpus of image data may be used to train such a system.

In some implementations, the graph 102 can represent an environment in the vicinity of a partially- or fully-autonomous vehicle (which may be a robot), each node in the graph 102 can represent a respective agent in the environment (e.g., a pedestrian, bicyclist, vehicle, etc.) or an element of the environment (e.g., traffic lights, traffic signs, road lanes, etc.), and the task prediction 112 can predict, e.g., a respective future trajectory of one or more of the agents represented by nodes in the graph. The node features may represent relevant aspects of the nodes, e.g. the agent type and motion, or element type. The edges may, e.g., represent spatial and/or logical relationships between the nodes, e.g. physical proximity, whether or not an agent or element is in, associated with, or connected by, the same road or road lane, and so forth. For example, the prediction output 112 can characterize a respective likelihood that a vehicle agent represented by a node in the graph 102 will make one or more possible driving decisions, e.g., going straight, changing lanes, turning left, or turning right. In this example, to predict a future trajectory of an agent represented by a node in the graph 102, the system 100 can process the updated node features generated by the neural network 110 for only the node representing the agent, i.e., without processing the updated node features for the other nodes in the graph. Optionally the task prediction 112 may be used by the vehicle to make a decision, e.g. to control motion of the vehicle, e.g. to brake and/or steer in response to a state of the environment. Such a system can be trained using, e.g. data collected from vehicles, and/or cameras, and/or road and street map data and/or using data from one of the several open source datasets for autonomous driving.

In some implementations, the graph 102 can represent a social network (e.g., on a social media platform), each node in the graph 102 can represent a respective person in the social network, each edge in the graph 102 can represent, e.g., a relationship between two corresponding people in the social network (e.g., a “follower” or “friend” relationship), and the task prediction 112 can predict, e.g., which people in the social network are likely to perform a certain action in the future (e.g., purchase a product or attend an event). The edges may be weighted according to a closeness of the relationship.

In some implementations, the graph 102 can represent a road network, each node in the graph 102 can represent a route segment in the road network, each edge in the graph 102 can represent that two corresponding route segments are connected in the road network, and the task prediction 112 can predict, e.g., a time or fuel required to traverse a specified path through the road network, or can (directly) predict a specified path through the road network from a start point to an end point. This may be used in a navigation system that determines a route from a start point to an end point for a user by processing the graph representing the road network, e.g. that minimizes travel time or fuel use. The node features can be any features that characterize the road segments, e.g. a speed limit, whether traffic lights are present. A directed edge can represent that travel between two nodes is only possible in one direction, or is easier in one direction than in the opposite direction; the edges may be weighted. Such a system can be trained using, e.g. data collected from vehicles, and/or cameras, and/or road and street map data and/or using data from one of the several open source datasets for autonomous driving.

In some implementations, the graph 102 can be a computational graph that represents, e.g., computational operations performed by a neural network model, each node in the graph 102 can represent a group of one or more related computations (e.g., operations performed by a group of one or more neural network layers), and each (directed) edge in the graph 102 can represent that an output of one group of computations is provided as an input to another group of computations. In general the node features may comprise features representing the group of one or more related computations represented by a node. In these implementations, the task prediction 112 can predict, e.g., a respective computing unit (i.e., from a set of available computing units) that should perform the operations corresponding to each node in the graph, e.g., to minimize a time, memory use, or electrical energy required to perform the operations defined by the graph. Each computing unit can be, e.g., a respective thread, central processing unit (CPU), or graphics processing unit (GPU). That is, such a system may be used to assign the computational operations performed by the neural network model to the computing units by identifying a respective computing unit that should perform the operations corresponding to each node in the graph.

In some implementations, the graph 102 can represent a protein, each node in the graph 102 can represent a respective amino acid, or a secondary structural element, in the amino acid sequence of the protein. Node features can encode the characteristics of a node, e.g. the type, and/or position, and/or orientation of the element (amino acid or structural element) that it represents. Each edge in the graph 102 can represent, e.g., that two corresponding amino acids in the protein are separated by less than a threshold distance (e.g., 8 Angstroms) in a structure of the protein, and/or an interaction between nodes such as a chemical or hydrogen bond; directed edges can encode, e.g., geometric considerations. In these implementations, the task prediction 112 can predict, e.g., a stability of the protein, or a function of the protein, e.g. whether or not it binds to a particular site or is bound to by a particular molecule. Thus the system can be used for screening proteins to identify a drug, e.g. an agonist or antagonist of a receptor or enzyme or an antibody to bind to an antibody target or to prevent binding of another ligand and prevent activation of a relevant biological pathway. This can involve processing a graph 102 representing a plurality of proteins, and using the predicted output to identify one or more proteins with the desired function and/or stability, to identify such a drug. Such a system can be trained on a corpus of data comprising proteins and their known properties; there are several large databases of this type. Once identified the drug may be further evaluated in silico and/or synthesized. It may be tested in vitro, and/or in vivo.

As used throughout this specification, a “graph” refers to a data structure that includes at least: (i) a set of nodes, and (ii) a set of edges. The graph is a “directed” graph, i.e., such that each edge that connects a pair of nodes is defined as pointing from the first node to the second node; e.g. (u, v) or the subscript u, v denotes a connection from node u to node v.

The graph data 104 defining the graph 102 can include data defining the nodes and the edges of the graph 102, and can be represented in any appropriate numerical format.

For example, a graph 102 can be defined by what is known as an “adjacency matrix” that includes a number of rows and a number of columns equal to the number of nodes in the graph. Each entry (i, j) in the adjacency matrix can have value 1 (or some other predefined value) if the graph includes an edge connecting node i and node j, and value 0 (or some other predefined value) otherwise. Alternatively, when the edges of the graph are weighted, each entry can assign a weight, e.g., between zero and one, to the corresponding edge, i.e., so that the entry is zero when there is no corresponding edge and has a non-zero value that represents the weight of the edge when there is a corresponding edge.

As another example, a graph can be defined by a set of tuples {(i, j)}, where each tuple (i, j) represents an edge in the graph connecting the node i and node j.

As another example, a graph 102 can be characterized by what is known as a “degree matrix”. A degree matrix of a graph 102 is a diagonal matrix that includes a number of rows and a number of columns equal to the number of nodes in the graph. Each entry (i, i) along the diagonal of the degree matrix can have a value equal to the degree of the corresponding node i. The degree of the node can refer to the in-degree of the node or the out-degree of the node, where the in-degree is the number of edges that connect to the node from any other node and the out-degree is the number of edges that connect from the node to any other node. Each entry not along the diagonal can be zero.

Optionally, either the degree matrix or the adjacency matrix or both can be symmetrized, i.e., to generate a symmetrized degree matrix, D_{S}, or a symmetrized adjacency matrix, A_{S}. In general a symmetrized adjacency matrix is one that has been modified so that it does not distinguish between different edge directions and symmetrized degree matrix is one that has been modified so that it does not distinguish between indegree and outdegree for the graph nodes. For example, adjacency matrix can be symmetrized by combining it with its transpose, e.g. as A_{S}=A∨A^{T} or as

$${A}_{S} = \frac{1}{2} ( A ⋁ {A}^{T} )$$

when the adjacency matrix contains weights. The degree matrix can be symmetrized by determining each of its diagonal elements as D_{S}(u, u)=Σᵥ A_{S}(u, v) (the off-diagonal elements are zero).

As used throughout this specification, an “embedding” refers to an ordered collection of numerical values, e.g., a vector, matrix, or other tensor of numerical values.

To generate the task prediction 112, the system 100 obtains the graph data 104 representing the input directed graph 102. Generally, in addition to specifying the connectivity of the graph, the graph data 104 includes respective node features (a respective node “embedding”) for each of the nodes in the graph 102. Optionally, the graph data 104 can also include additional features. For example the graph data 104 can also include a respective edge feature (a respective edge “embedding”) for each of the edges in the graph 102.

A positional encoding system 120 within the system 100 processes at least a portion of the graph data 104 to generate a respective positional encoding for each of the nodes in the graph. Generally, a positional encoding is an embedding that, e.g., has the same dimensionality as the node features in the graph data 104, and that represents the position of each of the nodes within the graph 102. As will be described in more detail below, the system 120 generates the positional encodings such that the positional encodings capture directedness in the graph. That is, modifying the direction of any given edge within the graph 102 will generally result in a modification to at least one of the positional encodings for at least one of the nodes in the graph 102. In general the positional encodings will also capture information relating to the position (connectedness) of a node in the graph in relation to other nodes of the graph, and may also capture some notion of distance between nodes.

The system 120 then generates an input sequence 114 that includes a respective input position corresponding to each of the nodes in the graph 120 and includes, at each of the input positions, a respective (combined) feature vector for the node corresponding to the input position that is based on both (i) the node features for the node and (ii) the positional encoding for the node. Although referred to as an input sequence with input positions, an input position merely indexes an element of the input sequence. Thus the input sequence has input elements, each input element corresponds to a node, and each input element comprises the respective (combined) feature vector for the node (based on the node features and positional encoding for the node).

The system 100 then processes the input sequence 114 using the neural network 110 to generate a predicted output, i.e., the task prediction 112, that characterizes the input directed graph 102.

The neural network 110 can generally have any of a variety of architectures that allow the neural network 110 to process an input that includes the input sequence 114 to generate an output having the format of, i.e. appropriate to, the task prediction 112.

For example, the neural network 110 can be a Transformer neural network. That is, the neural network 110 can be a neural network that includes a sequence of layer blocks that each update the input sequence 114, with each layer block including a Transformer layer that applies self-attention as part of updating the input sequence 114.

A Transformer layer that applies self-attention may also be referred to as a self-attention layer. In general it has an attention layer input for each element of an input sequence and is configured to apply an attention mechanism over the attention layer input to generate an attention layer output for each element of the input sequence. The attention layer input and the attention layer output generally comprise vectors of the same dimension. There are many different attention mechanisms that may be used. For example the attention mechanism can maps a query, Q, and a set of key-value pairs, K, V, to an output, where the query, keys, and values are all vectors. The output is computed as a weighted sum of the values, where the weight assigned to each value is computed by a compatibility function e.g. a dot product or scaled dot product, of the query with the corresponding key. Vectors Q, K and V may be obtained, e.g. by applying a learned matrix to an input; for a self-attention they are all derived from the same attention layer input.

As another example, the neural network 110 can be a neural network that includes both Transformer layers and graph neural network (GNN) layers. That is, the neural network includes a sequence of layer blocks, with each layer block including both a Transformer layer block and a graph neural network (GNN) layer block. In general a graph neural network layer block is a neural network layer block that is configured to process an input graph to generate an output graph, each typically defined by a set of nodes with associated node features, and a set of edges that connect the nodes (optionally having edge features).

These examples are described in more detail below with reference to FIG. 1B.

The neural network 110 can generally be trained using any appropriate training technique for the task that the neural network 110 is configured to perform. For example, for a classification task, the neural network 110 can be trained on training data for the task that includes, for each of multiple training graphs, a corresponding set of training graph data and a corresponding target classification. The neural network 110 can then be trained on the training data to optimize an objective that includes a classification loss, e.g., a cross-entropy loss or other appropriate function, using any appropriate machine learning technique, e.g., a stochastic gradient descent-based technique. As another example, for a regression task, the neural network 110 can be trained on training data for the task that includes, for each of multiple training graphs, a corresponding set of training graph data and a corresponding target regression output. The neural network 110 can then be trained on the training data to optimize an objective that includes a regression loss, e.g., a mean squared error loss, a 12 distance loss, or other appropriate loss, using any appropriate machine learning technique, e.g., a stochastic gradient descent-based technique. In either of these examples, the neural network 110 can optionally be pre-trained through unsupervised learning before being trained on the task-specific training data.

FIG. 1B shows an example of two architectures 150 and 160 of the neural network 110.

In the example of FIG. 1B, the input graph 102 includes n nodes and m edges. The connectivity of the graph 102 is represented by an adjacency matrix A. Generally, the graph data 104 also includes a respective node features for each of the n nodes and, in some implementations, a respective edge embedding for each of the m edges.

As shown in FIG. 1B, when the neural network 110 has the architecture 150, the neural network 110 includes/layer blocks 152. Each layer block 152 updates the input sequence by processing the input sequence using a respective Transformer layer. In this particular example, each layer block 152 generates queries Q, keys K, and values V from the sequence received as input by the layer block 152 and the Transformer layer within the layer block 152 applies self-attention using Q K and V in order to update the sequence.

Thus, in this architecture, the neural network 110 includes a sequence of layer blocks, with each layer block including a Transformer layer.

Accordingly, the system 100 combines the positional encodings computed by the system 120 with the node features for each of the n nodes, e.g., by summing, for each node, the positional encoding for the node with the features for the node, to generate a combined feature vector for the node.

The neural network 110 then uses the combined feature vectors for the nodes to generate Q, K, and V for the first layer block 152. For subsequent layer blocks, the neural network 110 uses the output of the preceding layer block to generate Q, K, and V for the layer block.

As also shown in FIG. 1B, when the neural network 110 has the architecture 160, the neural network 110 includes/layer blocks 162. Each layer block 162 includes a respective GNN layer and a respective Transformer layer and updates the input sequence by processing the input sequence using the respective Transformer layer. In particular, each layer block 162 generates queries Q and keys K by applying the respective GNN layer to the sequence received as input by the layer block 162, the edge features for the edges, and the adjacency matrix. The transformer layer within the layer block 152 applies self-attention using Q K and V, generated from the input sequence, in order to update the sequence. Optionally, the layer block 162 also updates the edge features for the edges of the graph.

Thus, in this architecture, the neural network 110 includes a sequence of layer blocks, with each layer block including a Transformer layer and a GNN layer. The GNN layers within the layer blocks can have any appropriate GNN architecture, e.g., a graph convolutional network (GCN) architecture, a message passing neural network (MPNN) architecture, a graph attention network (GAT) architecture, and so on.

Accordingly, the system 100 combines the positional encodings computed by the system 120 with the node features for each of the n nodes, e.g., by summing, for each node, the positional encoding for the node with the features for the node, to generate a combined feature vector for the node.

The neural network 110 then uses the combined feature vectors for the nodes to generate Q, K, and V for the first layer block 162, e.g., by applying a linear transformation or other learned transformation to the combined feature vectors to generate V and by applying the GNN layer to the combined feature vectors, the edge features, and the adjacency matrix to generate Q and K. For subsequent layer blocks, the neural network 110 can generate V from the output of the preceding layer block and can generate Q and K by processing the output of the preceding layer block, either the original or the updated edge features, and the adjacency matrix using the GNN layer within the layer block.

In either the architecture 150 or 160, the neural network 110 can also include additional layers in addition to the layer blocks. For example, the neural network 110 can include an output subnetwork, e.g., a fully-connected subnetwork or a Transformer sub-network, that processes the updated features generated by the last layer block for one or more of the nodes in the graph to generate the task prediction 112.

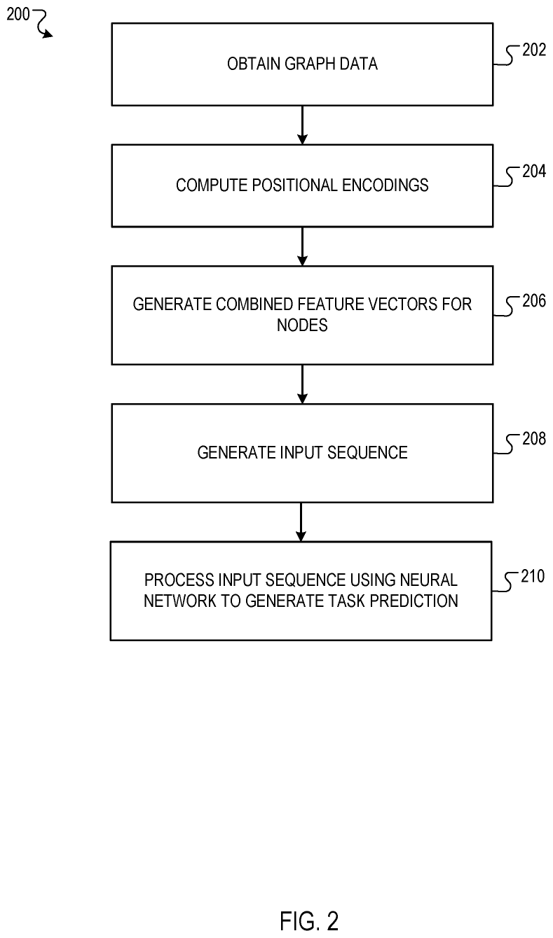

FIG. 2 is a flow diagram of an example process 200 for processing graph data to generate a task prediction. For convenience, the process 200 will be described as being performed by a system of one or more computers located in one or more locations. For example, a graph processing system, e.g., the graph processing system 100 of FIG. 1A, appropriately programmed in accordance with this specification, can perform the process 200.

The system obtains graph data representing an input graph (step 202). As described above, the input graph includes a set of nodes and a set of directed edges that each connect a respective pair of nodes and the graph data includes respective node features for each of the nodes and, optionally, edge features for each of the edges.

The system generates a respective positional encoding for each of the nodes in the graph (step 204). Generally, to compute the positional encodings, the system uses a Magnetic Laplacian of the input graph.

The Magnetic Laplacian of the input graph is direction-aware generalization of the combinatorial Laplacian, also known as the graph Laplacian or Laplacian matrix. In other words, the Magnetic Laplacian is based on a respective direction of each of the directed edges in the input directed graph.

The graph Laplacian is a standard mathematical construct, and is a matrix form of the Laplace operator; there are unnormalized or normalized versions. The Magnetic Laplacian, L, extends the graph Laplacian to directed graphs and is used in, inter alia, calculations involving magnetic flux. More specifically the Magnetic Laplacian is a graph Laplacian matrix (equal to its conjugate transpose) with complex (real and imaginary) valued elements that encode the direction of the edges as phase information. The Magnetic Laplacian is constructed as a Hermitian matrix, and thus the eigendecomposition is well-behaved and the eigenvectors are orthogonal, which is useful for the position encodings. There is a choice of ways in which the Magnetic Laplacian may be constructed as a Hermitian matrix.

The unnormalized or normalized versions of the graph Laplacian can be determined from a combination of the degree matrix and the adjacency matrix for the graph. The Magnetic Laplacian can likewise be determined from a combination of the degree matrix for the graph and the adjacency matrix for the graph but the adjacency matrix is modified so that it is a Hermitian matrix with complex valued elements (and hence so also is L). As mentioned, there is more than way in which this modification may be made. In the example described later the degree matrix and the adjacency matrix are both symmetrized so that they are undirected, i.e. do not represent directed edges, and each element of the adjacency matrix is multiplied by a complex phase, exp(iθ), that encodes the edge direction. This makes the adjacency matrix, and hence also the Magnetic Laplacian, Hermitian.

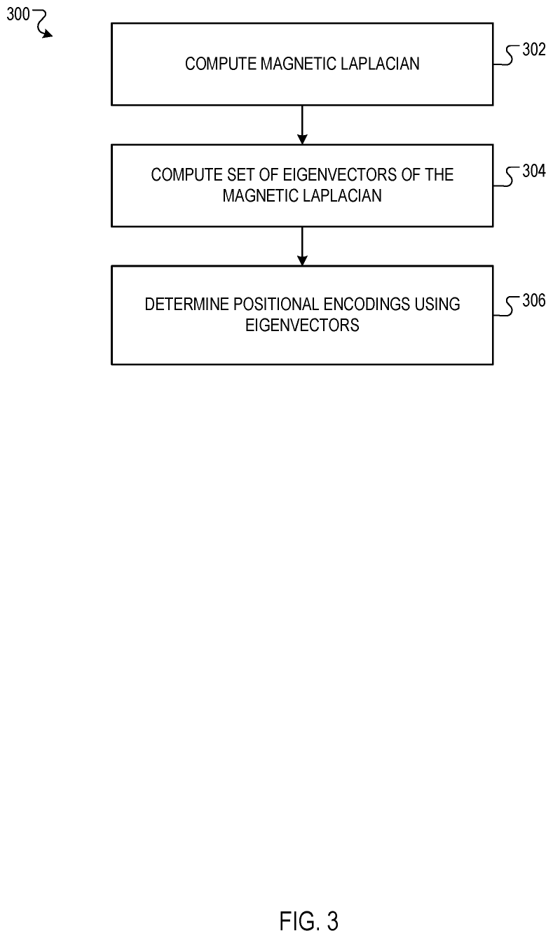

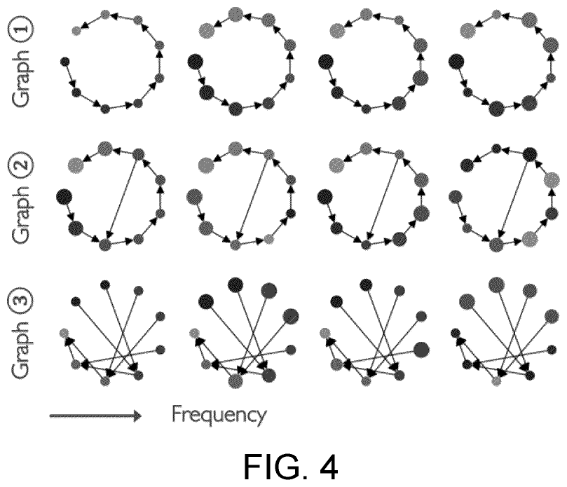

Computing positional encodings using Magnetic Laplacians is described in more detail below with reference to FIGS. 3 and 4.

The system generates a respective combined feature vector for each of the nodes in the graph from (i) the node features for the node and (ii) the positional encoding for the node (step 206).

That is, the system generates the combined feature vector for a given node by combining the node features for the node and the positional encoding for the node. For example, the system can sum the node features for the node and the positional encoding for the node. As another example, the system can concatenate the node features for the node and the positional encoding for the node.

The system generates an input sequence that includes a respective input position corresponding to each of the nodes and includes, at each input position, the respective combined feature vector for the node corresponding to the input position (step 208).

The system processes the input sequence using a neural network to generate a predicted output that characterizes the input directed graph (step 210). For example, as described above, the neural network can be a Transformer neural network or a neural network that includes both Transformer layers and graph neural network layers. In some implementations, the neural network also processes respective edge features for each of the edges in the graph to make the prediction.

FIG. 3 is a flow diagram of an example process 300 for computing positional encodings for the nodes of a directed graph. For convenience, the process 300 will be described as being performed by a system of one or more computers located in one or more locations. For example, a graph processing system, e.g., the graph processing system 100 of FIG. 1A, appropriately programmed in accordance with this specification, can perform the process 300.

The system computes a Magnetic Laplacian of the input directed graph that is based on a respective direction of each of the directed edges in the input directed graph (step 302). The Magnetic Laplacian is a generalization of the combinatorial Laplacian that encodes the direction of directed edges within the graph with complex numbers.

For example, the system can compute the (unnormalized) Magnetic Laplacian as:

$${D}_{S} - {A}_{S} ⊙ exp ( i {Θ}^{( q )} ) ,$$

where D_{S} is a symmetrized degree matrix of the input directed graph, A_{S} is a symmetrized adjacency matrix, i is the imaginary unit, i.e., \sqrt{−1}, and ⊙ denotes elementwise multiplication, and the operation exp (if (a) yields a matrix that has entries that are based on (a) the respective direction of each of the directed edges in the input directed graph and (b) a potential value q.

In some implementations

$${Θ}_{u , v}^{( q )} = 2 π q ( {A}_{u , v} - {A}_{v , u} )$$

where A_{u,v} denotes element (u, v) of the symmetrized adjacency matrix, representing the connection between nodes u and v, i.e. a directed edge. Thus, the entries of the matrix exp(iΘ^{(q)}) are based on both (a) the respective direction of each of the directed edges in the input directed graph and (b) a potential value q.

As another example, the system can compute the (normalized) Magnetic Laplacian as a degree-normalized version of the above:

$$I - ( {{D}_{S}}^{- \frac{1}{2}} {A}_{S} {{D}_{S}}^{- \frac{1}{2}} ) ⊙ exp ( i {Θ}^{( q )} )$$

where I is the identity matrix. Thus, in this case, the Magnetic Laplacian is equal to the difference between an identity matrix and an element-wise product between (i) a first matrix derived from the symmetrized adjacency and degree matrices and (ii) a matrix that has entries that are based on (a) the respective direction of each of the directed edges in the input directed graph and (b) the potential value q. This expression can be re-written in other ways.

In either expression, the exp (iΘ^{(q)}) term encodes edge direction. For example, when the edges are unweighted, the expression resolves to 1 if A_{u,v}=A_{v,u} and, otherwise, to exp (±(i2πq), with the sign encoding the edge direction. When the edges are weighted, the expression similarly encodes edge direction when there is only an edge from u to v or from v to u or a (directed) difference between edge weights when there are edges from u to v and from v to u.

As described above, the Magnetic Laplacian depends on the potential value q. In particular, the potential value q determines the ratio of the real and the imaginary parts of any given entry of the Magnetic Laplacian. In other words, the potential q determines the strength of the induced phase shift by each edge of the graph. Thus q plays a similar role to frequency, more particularly the lowest frequency, in sinusoidal encodings.

In some implementations, the system sets the potential value q based on (i) a relative potential value q′ and (ii) the number of purely directed edges in the input directed graph. An edge from node u to node v is a purely directed edge if and only if there is no node from (connecting) node v to node u in the graph. Generally, the relative potential value q′ is a constant, e.g., equal to 0.1 or 0.25.

For example, the system can set the potential value q less than or equal to the relative potential value divided by the minimum of (i) the total number of nodes in the graph n, (ii) the total number of purely directed edges in the graph, and (iii) one. Scaling the potential based on the number of nodes, and in implementations also on the number of purely directed edges, can in some cases improve performance of the system 100.

The system then computes the positional encodings for the nodes of the directed graph using the Magnetic Laplacian. Because the system uses the Magnetic Laplacian, which is based on the directions of the directed edges in the graph, to compute the positional encodings, the positional encodings are directionally-aware and capture the directedness of the directed graph.

For example, the system can compute the positional encodings using the Magnetic Laplacian by performing steps 304 and 306.

In some cases, after the system computes the positional encodings for the nodes of the directed graph using the Magnetic Laplacian, e.g., as described below, the system combines, for each node, the computed positional encoding for the node with a sinusoidal positional encoding for the input position corresponding to the node to generate the final positional encoding for the node. For example, the system can add the computed positional encoding for the node with the sinusoidal positional encoding. That is, in some implementations, the system incorporates information from both the Magnetic Laplacian (which is directionally-aware) and the sinusoidal positional encodings which are not directionally-aware) in the final positional encodings. For example a D-dimensional sinusoidal positional embedding for a position with integer index u may be computed for each dimension das sin ωu or cos ωu where ω=N^{-2d/D} where N is a large number, e.g. 10000.

The system computes a set of eigenvectors of the Magnetic Laplacian (step 304). Generally, because the entries of the Magnetic Laplacian are complex, i.e. have real and imaginary components, each eigenvector also has a real and imaginary component. Thus, when there are n nodes in the graph, each eigenvector is an n×2-dimensional vector which includes a real component and an imaginary component for each node in the graph.

For example, the system can compute a set of eigenvalues of the Magnetic Laplacian and then select, as the set of eigenvectors, the eigenvectors associated with the k lowest (magnitude) eigenvalues of the Magnetic Laplacian, where k is a fixed number. Thus, when there are n nodes in the graph, the set of k eigenvectors results in a k×n×2 tensor.

The system generates the respective positional encodings from the set of eigenvectors (step 306). FIG. 4 illustrates the first four eigenvectors associated with the lowest four eigenvalues, for three simple example graphs. In FIG. 4 the node size indicates magnitudes and the node shade indicates phase (lighter indicates a greater imaginary component). It can be seen that the eigenvectors encode a node's position and relative distances (in an undirected graph there would be no phase component; in effect the phase component would be the same for all the nodes). There are many ways in which the set of eigenvectors can be used as positional encodings. They can be used without further processing, or some additional processing can be applied.

In some implementations, the system can preprocess the k eigenvectors before using the eigenvectors as positional encodings.

For example, the system can normalize the set I of eigenvectors. In particular, the system can perform scaling and rotation to account for the fact that eigenvectors of a given matrix may not be unique. However this is not essential, and in practice can be omitted depending, e.g., upon the application. One example algorithm for performing this scaling and rotation to normalize the k eigenvectors is shown below in Table 1.

TABLE 1

| 1: Input: Eigenvectors Γ ∈ [symbol] ^{n×k} | |
|---|---|
| 2: j ← argmax(\| [symbol] (Γ)\|, axis = 0) | // shape k |
| 3: s ← sign( [symbol] (Γ)[0 : n − 1, j]) | // shape k |
| 4: Γ ← s ⊙ Γ | |
| 5: j ← max( [symbol] (Γ[:, 0])) | // scalar |

6: α ← ∠(Γ[j, :])
7: Γ ← exp(−iα)^{τ} ⊙ Γ
8: Return Γ

Optionally, after normalization, the system can then process the set of eigenvectors using a sign neural network to generate the respective positional encodings.

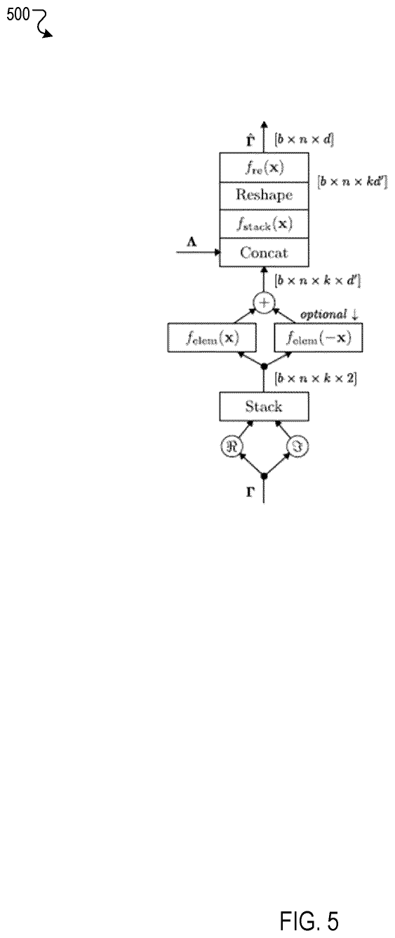

FIG. 5 shows an example architecture 500 of a position encoding processing neural network that may optionally be used to further process the set of eigenvectors to generate a respective positional encoding for each of the nodes in the graph. The position encoding processing neural network is also referred to herein as a sign neural network. Processing the eigenvectors in this way before using them as position encodings is not essential but may provide benefits in some applications. The neural network of FIG. 5 models the node-wise interactions between eigenvectors for each node u, in particular by applying self-attention independently for each node u over its k eigenvector embeddings.

As shown in FIG. 5, the sign neural network receives as input the set I of eigenvectors and generates as output a d dimensional positional encoding for each of the n nodes in the graph. In FIG. 5, b is the batch dimension and is equal to one if the system is processing the set of eigenvectors for a single graph. As shown in FIG. 4, in some implementations, the system ignores sign-invariance and uses only fₑₗₑₘ(x), while in other implementations the neural network is sign-invariant and uses both fₑₗₑₘ(x) and fₑₗₑₘ(−x), where fₑₗₑₘ(⋅) is a permutation-equivariant learned function over the n nodes, e.g., point-wise multi-layer perceptron (MLP) or a GNN. Similarly, in the Figure f_{stack}(⋅) and fᵣₑ(⋅) in FIG. 5 are additional learned functions, e.g., respective MLPs or GNNs. Additionally, as shown in FIG. 5, in some implementations, the sign neural network also receives as input the corresponding eigenvectors Λ for the set Γ of eigenvectors.

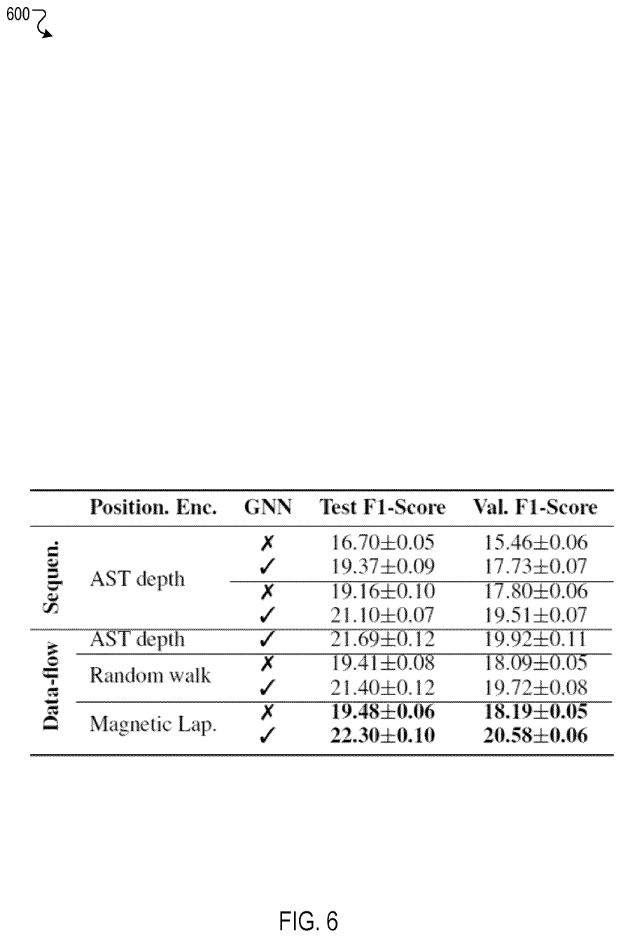

FIG. 6 shows the results 600 of the described approach (“Magnetic Laplacian”) on a task that requires making a prediction for a computer program. In particular, the task in FIG. 6 is a function name prediction task that requires processing an input representing a function or a method within a computer program and predicting the name of the function.

The results 600 show the results of an approach that represents the computer program as a sequence and that uses abstract syntax tree (AST) depth positional encodings. The results 600 also show the results of approaches that represent the computer program as a directed data-flow graph and that use AST depth positional encodings, positional encodings derived from random walks through the graph, and positional encodings computed using Magnetic Laplacians as described above. As seen from FIG. 6, the approach that uses Magnetic Laplacian positional encodings outperforms all other approaches on both test and validation F1-scores, regardless of whether the neural network includes a GNN or does not include a GNN, i.e., includes only self-attention layers.

Generally, the sign neural network is trained jointly with the neural network 110, e.g., by backpropagating gradients through the neural network 110 and into the sign neural network, during the training of the neural network 110.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:
Clause 1. A method performed by one or more computers, the method comprising
   obtaining graph data representing an input directed graph that comprises a set of nodes and a set of directed edges that each connect a respective pair of nodes, the graph data comprising respective node features for each of the nodes;
   computing a Magnetic Laplacian of the input directed graph that is based on a respective direction of each of the directed edges in the input directed graph;
   generating a respective positional encoding for each of the nodes in the graph using the Magnetic Laplacian;
   generating a respective combined feature vector for each of the nodes in the graph from (i) the node features for the node and (ii) the positional encoding for the node;
   generating an input sequence that includes a respective input position corresponding to each of the nodes and comprises, at each input position, the respective combined feature vector for the node corresponding to the input position; and
   processing the input sequence using a neural network to generate a predicted output that characterizes the input directed graph.
Clause 2. The method of clause 1, wherein generating a respective combined feature vector for each of the nodes in the graph from (i) the node features for the node and (ii) the positional encoding for the node comprises:
   summing the node features for the node and the positional encoding for the node.
Clause 3. The method of clause 1 or clause 2, wherein generating a respective positional encoding for each of the nodes in the graph using the Magnetic Laplacian comprises:
   computing a set of eigenvectors of the Magnetic Laplacian; and
   generating the respective positional encodings from the set of eigenvectors.
Clause 4. The method of clause 3, wherein the set of eigenvectors includes eigenvectors associated with the k lowest eigenvalues of the Magnetic Laplacian.
Clause 5. The method of clause 3 or clause 4, wherein generating the respective positional encodings from the set of eigenvectors comprises:
   processing the set of eigenvectors using a sign neural network to generate the respective positional encodings.
Clause 6. The method of any preceding clause, wherein the neural network is a Transformer neural network.
Clause 7. The method of any preceding clause, wherein the neural network is a neural network that comprises a sequence of layer blocks, and wherein each layer block includes a Transformer layer block and a graph neural network (GNN) layer block.
Clause 8. The method of any preceding clause, wherein generating a respective positional encoding for each of the nodes in the graph using the Magnetic Laplacian comprises:
   generating, for each node, the respective positional encoding for the node from (i) a set of eigenvectors of the Magnetic Laplacian and (ii) a sinusoidal positional encoding for the input position corresponding to the node.
Clause 9. The method of any preceding clause, wherein the Magnetic Laplacian is equal to a difference between:
   (i) a symmetrized degree matrix of the input directed graph, and
   (ii) an element-wise product between a symmetrized adjacency matrix and a matrix that has entries that are based on (a) the respective direction of each of the directed edges in the input directed graph and (b) a potential value q.
Clause 10. The method of any one of clauses 1-8, wherein the Magnetic Laplacian is equal to a difference between:
   (i) an identity matrix, and
   (ii) an element-wise product between (i) a first matrix derived from a symmetrized degree matrix of the input directed graph and a symmetrized adjacency matrix of the input directed graph and (ii) a matrix that has entries that are based on (a) the respective direction of each of the directed edges in the input directed graph and (b) a potential value q.
Clause 11. The method of clause 9 or clause 10, further comprising:
   setting the potential value q based on (i) a relative potential value q′ and (ii) a number of purely directed edges in the input directed graph.
Clause 12. One or more non-transitory computer storage media storing instructions that when executed by one or more computers cause the one or more computers to perform operations of the respective method of any one of clauses 1-11.
Clause 13. A system comprising:
   one or more computers; and
   one or more storage devices communicatively coupled to the one or more computers, wherein the one or more storage devices store instructions that, when executed by the one or more computers, cause the one or more computers to perform operations of the respective method of any one of clauses 1-11.

1. A method performed by one or more computers, the method comprising obtaining graph data representing an input directed graph that comprises a set of nodes and a set of directed edges that each connect a respective pair of nodes, the graph data comprising respective node features for each of the nodes;
computing a Magnetic Laplacian of the input directed graph that is based on a respective direction of each of the directed edges in the input directed graph;
generating a respective positional encoding for each of the nodes in the graph using the Magnetic Laplacian;
generating a respective combined feature vector for each of the nodes in the graph from (i) the node features for the node and (ii) the positional encoding for the node;
generating an input sequence that includes a respective input position corresponding to each of the nodes and comprises, at each input position, the respective combined feature vector for the node corresponding to the input position; and
processing the input sequence using a neural network to generate a predicted output that characterizes the input directed graph.

2. The method of claim 1, wherein generating a respective combined feature vector for each of the nodes in the graph from (i) the node features for the node and (ii) the positional encoding for the node comprises:
summing the node features for the node and the positional encoding for the node.

3. The method of claim 1, wherein generating a respective positional encoding for each of the nodes in the graph using the Magnetic Laplacian comprises:
computing a set of eigenvectors of the Magnetic Laplacian; and
generating the respective positional encodings from the set of eigenvectors.

4. The method of claim 3, wherein the set of eigenvectors includes eigenvectors associated with the k lowest eigenvalues of the Magnetic Laplacian.

5. The method of claim 3, wherein generating the respective positional encodings from the set of eigenvectors comprises:
processing the set of eigenvectors using a sign neural network to generate the respective positional encodings.

6. The method of claim 1, wherein the neural network is a Transformer neural network.

7. The method of claim 1, wherein the neural network is a neural network that comprises a sequence of layer blocks, and wherein each layer block includes a Transformer layer block and a graph neural network (GNN) layer block.

8. The method of claim 1, wherein generating a respective positional encoding for each of the nodes in the graph using the Magnetic Laplacian comprises:
generating, for each node, the respective positional encoding for the node from (i) a set of eigenvectors of the Magnetic Laplacian and (ii) a sinusoidal positional encoding for the input position corresponding to the node.

9. The method of claim 1, wherein the Magnetic Laplacian is equal to a difference between:
(i) a symmetrized degree matrix of the input directed graph, and
(ii) an element-wise product between a symmetrized adjacency matrix and a matrix that has entries that are based on (a) the respective direction of each of the directed edges in the input directed graph and (b) a potential value q.

10. The method of claim 1, wherein the Magnetic Laplacian is equal to a difference between:
(i) an identity matrix, and
(ii) an element-wise product between (i) a first matrix derived from a symmetrized degree matrix of the input directed graph and a symmetrized adjacency matrix of the input directed graph and (ii) a matrix that has entries that are based on (a) the respective direction of each of the directed edges in the input directed graph and (b) a potential value q.

11. The method of claim 9, further comprising:
setting the potential value q based on (i) a relative potential value q′ and (ii) a number of purely directed edges in the input directed graph.

12. One or more non-transitory computer storage media storing instructions that when executed by one or more computers cause the one or more computers to perform operations of comprising:
obtaining graph data representing an input directed graph that comprises a set of nodes and a set of directed edges that each connect a respective pair of nodes, the graph data comprising respective node features for each of the nodes;
computing a Magnetic Laplacian of the input directed graph that is based on a respective direction of each of the directed edges in the input directed graph;
generating a respective positional encoding for each of the nodes in the graph using the Magnetic Laplacian;
generating a respective combined feature vector for each of the nodes in the graph from (i) the node features for the node and (ii) the positional encoding for the node;
generating an input sequence that includes a respective input position corresponding to each of the nodes and comprises, at each input position, the respective combined feature vector for the node corresponding to the input position; and
processing the input sequence using a neural network to generate a predicted output that characterizes the input directed graph.

13. A system comprising:
one or more computers; and
one or more storage devices communicatively coupled to the one or more computers, wherein the one or more storage devices store instructions that, when executed by the one or more computers, cause the one or more computers to perform operations comprising:
obtaining graph data representing an input directed graph that comprises a set of nodes and a set of directed edges that each connect a respective pair of nodes, the graph data comprising respective node features for each of the nodes;
computing a Magnetic Laplacian of the input directed graph that is based on a respective direction of each of the directed edges in the input directed graph;
generating a respective positional encoding for each of the nodes in the graph using the Magnetic Laplacian;
generating a respective combined feature vector for each of the nodes in the graph from (i) the node features for the node and (ii) the positional encoding for the node;
generating an input sequence that includes a respective input position corresponding to each of the nodes and comprises, at each input position, the respective combined feature vector for the node corresponding to the input position; and
processing the input sequence using a neural network to generate a predicted output that characterizes the input directed graph.

14. The system of claim 13, wherein generating a respective combined feature vector for each of the nodes in the graph from (i) the node features for the node and (ii) the positional encoding for the node comprises:
summing the node features for the node and the positional encoding for the node.

15. The system of claim 13, wherein generating a respective positional encoding for each of the nodes in the graph using the Magnetic Laplacian comprises:
computing a set of eigenvectors of the Magnetic Laplacian; and
generating the respective positional encodings from the set of eigenvectors.

16. The system of claim 15, wherein the set of eigenvectors includes eigenvectors associated with the k lowest eigenvalues of the Magnetic Laplacian.

17. The system of claim 15, wherein generating the respective positional encodings from the set of eigenvectors comprises:
processing the set of eigenvectors using a sign neural network to generate the respective positional encodings.

18. The system of claim 13, wherein the neural network is a Transformer neural network.

19. The system of claim 13, wherein the neural network is a neural network that comprises a sequence of layer blocks, and wherein each layer block includes a Transformer layer block and a graph neural network (GNN) layer block.

20. The system of claim 13, wherein generating a respective positional encoding for each of the nodes in the graph using the Magnetic Laplacian comprises:
generating, for each node, the respective positional encoding for the node from (i) a set of eigenvectors of the Magnetic Laplacian and (ii) a sinusoidal positional encoding for the input position corresponding to the node.
